(19) United States
(12) Patent Application Publication
(10) Pub. No.: US 2026/0225966 A1
(43) Pub. Date: Aug. 6, 2026

(54) CERAMIC COMPONENT HAVING A SUPERHYDROPHILIC SURFACE REGION, METHOD FOR MANUFACTURING AND USE OF SUCH A CERAMIC COMPONENT

(71) Applicant: Fraunhofer-Gesellschaft zur Förderung der angewandten Forschung e.V., Munich (DE)

(72) Inventors: Fred FIETZKE, Dresden (DE); Maria lsabel BARRERA MARIN, Dresden (DE); Heidrun KLOSTERMANN, Dresden (DE)

(73) Assignee: Fraunhofer-Gesellschaft zur Förderung der angewandten Forschung e.V., Munich (DE)

(21) Appl. No.: 19/560,108

(22) Filed: Mar. 8, 2026

Related U.S. Application Data
(63) Continuation of application No. PCT/EP2024/073794, filed on Aug. 26, 2024.

(30) Foreign Application Priority Data
Sep. 26, 2023 (DE) 10 2023 126 146.0

(51) Int. Cl. C04B 41/87; C04B 41/45; C04B 41/89

(52) U.S. Cl. CPC C04B 41/87; C04B 41/4533; C04B 41/89

(57) ABSTRACT

A ceramic component having a superhydrophilic surface region is provided, and a method for manufacturing such a ceramic component is provided in which a base body consisting of a sintered ceramic is heated to a temperature of at least 400° C. within a vacuum chamber and then a tungsten trioxide layer is deposited on the heated base body, at least within the superhydrophilic surface region, by a pulsed magnetron sputtering process, wherein a pulse frequency in the range of 0.5 kHz to 100 kHz is used.

### CROSS-REFERENCE TO RELATED APPLICATIONS

This application is a continuation of international patent application PCT/EP 2024/073794 filed Aug. 26, 2024, which claims priority under 35 USC § 119 to German patent application 10 2023 126 146.0 filed Sep. 26, 2023. The entire contents of each of the above-identified applications are hereby incorporated by reference.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a schematic representation of an apparatus suitable for carrying out the method according to the invention;

FIG. 2 is a schematic representation of a section through a component according to the invention; and

FIG. 3 is a schematic representation of a section through an alternative component according to the invention.

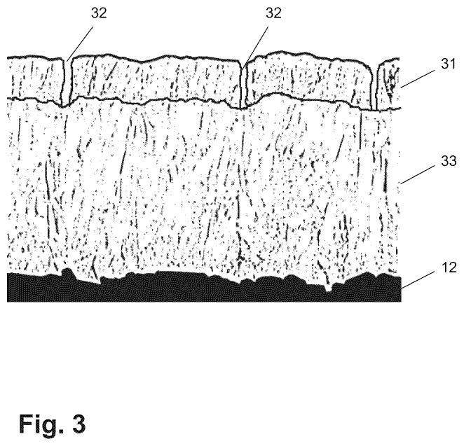

### DETAILED DESCRIPTION

The invention relates to a ceramic component which has superhydrophilic properties at least in one surface region and is therefore very wettable with water in this surface region. Furthermore, a method for manufacturing and a use of such a ceramic component having a superhydrophilic surface region is described.

It is known to modify the surface properties of components by depositing at least one layer on a surface region of the components. Thus, JP 2013-222 662 A describes dye-sensitized solar cells in which a porous layer including tungsten trioxide particles is deposited on a ceramic substrate. “BALAJI et al.: Porous orthorhombic tungsten oxide thin films: synthesis, characterization, and application in electrochromic and photochromic devices. In: Journal of Materials Chemistry, 21, 2011, 3940” describes tungsten trioxide layers that are deposited on glass substrates. In this case, the tungsten trioxide is at least partially formed as an orthorhombic phase and can be used in electrochromic and photochromic applications. JP 2015-199 065 A discloses tungsten trioxide layers which can be deposited on a substrate and used as photocatalyst layers. Tungsten trioxide layers are also known from US 2009/0268371 A 1 and can be used as capacitor electrodes. And US 2017/0284999 A 1 also describes tungsten trioxide layers as a component of gas sensors.

Furthermore, coatings that influence the wettability of component surfaces with water are also known. In some applications, it is desirable for components to have a water-repellent surface. Such surface regions having water-repellent properties are also referred to as hydrophobic. In contrast, there are also applications in which the surface of a component should be as wettable as possible with water. If a surface is easily wettable with water, this surface is also referred to as hydrophilic.

The angle formed by a drop of water on the component surface is often used as a measure of the wettability of a component surface with water. This angle is also known as the contact angle. While the contact angle is as large as possible for hydrophobic surfaces, the aim is to achieve the smallest possible contact angle for hydrophilic surfaces.

Hydrophilic properties are advantageous, for example, in glass substrates having an optical function, such as, for instance, mirrors in which fogging with small liquid droplets is to be prevented. Hydrophilic properties are also advantageous in modern heat pumps that are based on the electrocaloric effect. Electrocaloric heat pumps utilize the fact that certain materials change their temperature (for example, they heat up) when an electric field is applied to them. When the electric field is removed, the material cools down below its initial temperature. The material can then absorb thermal energy from a heat source. An efficient heat cycle can thus be established using electrocaloric materials. Since this effect is reversible, it can be used for both heating and cooling. In electrocaloric heat pumps, an electric field is applied to a material and switched off again several times per second, as described above. As a result, when the temperature of the material changes several times per second, the material surface is also coated with a liquid film several times per second, and this film then has to be removed several times per second. This requires material surfaces with very good hydrophilic properties.

Coatings have been developed that make it possible to achieve a contact angle of almost 0° on component surfaces. Such surfaces are also referred to as superhydrophilic. Since there is no exact definition of the term “superhydrophilic” in the scientific community and contact angles smaller than 5° can only be determined with insufficient accuracy using known measurement methods, in the sense of the invention such surface regions are to be considered to be superhydrophilic if a contact angle of less than 5° can be achieved when wetted with a drop of water.

EP 1 304 366 B 2 proposes first to deposit a photocatalytically active layer that includes at least one of the elements such as titanium, tungsten, tin, zinc, iron or silicon, on the surface of a substrate and then to expose this layer to sunlight in order to obtain a surface with hydrophilic properties. The photocatalytically active layer can be deposited, for example, by means of magnetron sputtering.

A photocatalytically active layer also serves as a basis for the formation of a hydrophilic surface in Masahiro Miyauchi et al, “Hydrophilic Layered SiO₂/TiO₂/WO₃ Thin Film for Indoor Anti-Fogging Coatings.” In this case, a photocatalytic layer of SiO₂, TiO₂, WO₃ or a mixture of at least two of the aforementioned oxides is first deposited on a substrate and then exposed to light irradiation. Using this approach, it was possible to maintain the hydrophilic properties for a period of up to 65 days.

WO 2009/092664 discloses processes in which a component made of glass or ceramic is provided with a superhydrophilic surface by wet-chemically depositing an oxide layer of at least one of the elements silicon, titanium and zinc on the surface of the component and subsequently cross-linking it by adding a substance.

All the above-described methods have in common that the hydrophilic properties achieved are only maintained for a relatively short period of time. Furthermore, the components that can be manufactured in this way are not very suitable for use in electrocaloric heat pumps, because it is not sufficiently possible to wet the surface with a liquid film several times per second with these.

The underlying technical problem of the invention is therefore to create a component having a superhydrophilic surface region which can overcome the disadvantages of the prior art. In particular, the superhydrophilic properties of a component according to the invention should be maintained for longer than is known from the prior art. Furthermore, the component should make it possible to wet the superhydrophilic surface region with a liquid film several times per second and to remove this film again. Furthermore, a method for manufacturing and a use of such a component having a superhydrophilic surface region will be specified.

A component according to the invention initially comprises a base body consisting of a sintered ceramic. The starting material for a sintered ceramic is known to be a ceramic powder, which may be mixed with water, binder, liquefier and other additives. Ceramic powders are essentially divided into the groups of silicates, oxides and non-oxides. All of the groups of ceramic powders can be used as starting material for the base body of a component according to the invention. The ceramic powder mixed with additives is pressed and then subjected to a sintering process in which most of the components of the additives, which are volatile at high temperatures, escape from the pressed molded piece. What remains is a ceramic molded piece in which the grain boundaries of the compressed ceramic powder particles can be detected using suitable means. Such a sintered ceramic is used as the base body in an inventive component.

According to the invention, an inventive component also includes a tungsten trioxide layer which is deposited on the base body at least within the surface region of the component in which superhydrophilic properties are to be formed. The layer material of the tungsten trioxide layer is more than 50% orthorhombic phase and has a porous nanostructure which includes gaps that grow from the grain boundaries of the sintered ceramic and extend along the layer thickness of the tungsten trioxide layer through the entire tungsten trioxide layer. These previously described material properties of the tungsten trioxide layer result in superhydrophilic properties on the component surface in the surface region in which the tungsten trioxide layer is deposited.

According to the invention, such a ceramic component having superhydrophilic properties within a surface region can be manufactured by heating a base body consisting of a sintered ceramic to a temperature of at least 400° C. within a vacuum chamber and then depositing a tungsten trioxide layer on the heated base body, at least within the surface region in which superhydrophilic properties are to be formed, by means of a pulsed magnetron sputtering process, where a pulse frequency in the range of 0.5 kHz to 100 kHz is used.

The invention is described in more detail below using exemplary embodiments.

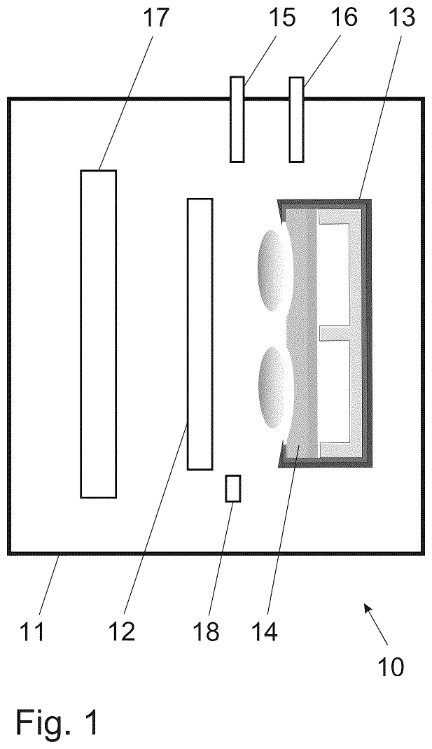

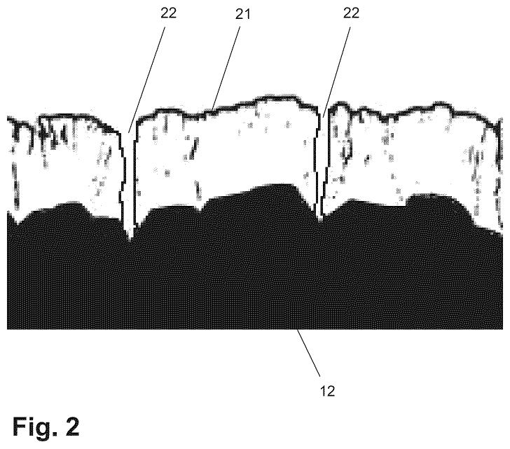

FIG. 1 schematically shows an apparatus 10 with which the method according to the invention can be carried out and a ceramic component according to the invention having a superhydrophilic surface region can be manufactured. FIG. 2 shows a schematic section of a component according to the invention manufactured by means of apparatus 10. The apparatus 10 includes a vacuum chamber 11 within which a tungsten trioxide layer 21 is to be deposited on one side of a plate-like base body 12. According to the invention, the base body 12 consists of a sintered ceramic. The tungsten trioxide layer 21 is to be deposited on the base body 12 by means of a reactive magnetron sputtering process. For this purpose, a magnetron 13 equipped with a tungsten target 14 is arranged inside the vacuum chamber 11 opposing the side of the base body 12 to be coated. To carry out the reactive magnetron sputtering process, the reactive gas oxygen is introduced into the vacuum chamber 11 through a first inlet 15 and the working gas argon through a second inlet 16. As an alternative to the working gas argon, all other inert gases known for magnetron sputtering processes can also be used as working gases.

According to the invention, the base body 12 consisting of a sintered ceramic is heated to a temperature of at least 400° C. before layer deposition. In a preferred embodiment of the invention, the base body 12 is heated to a temperature of at least 500° C. before layer deposition. A heating device 17, which in the exemplary embodiment is designed as a radiant heater, is used to heat the base body 12. Alternatively, other means can be used to heat the base body 12. For example, the base body 12 can be heated by means of bombardment with electrically charged particles, such as accelerated electrons or ions. Alternatively, the base body 12 can be heated with a laser beam.

After the base body 12 has been heated, the tungsten trioxide layer 21 is deposited by means of the magnetron 13, which sputters tungsten particles from the tungsten target 14. These particles combine with the reactive gas oxygen in a reactive process and are deposited as tungsten trioxide on the side of the base body 12 to be coated. Alternatively, a non-reactive sputtering process can be selected for depositing the tungsten trioxide layer, in which a target consisting of tungsten trioxide is sputtered by means of the magnetron 13. In such an alternative procedure, no reactive gas is admitted into the vacuum chamber 11 through the first inlet 15.

According to the invention, the deposition of the tungsten trioxide layer 21 on the heated base body 12 is carried out by means of a pulsed magnetron sputtering process, where a pulse frequency in the range of 0.5 kHz to 100 kHz is used. Using a pulse frequency in the range of 2 kHz to 10 kHz is particularly advantageous for forming a desired layer structure.

In the procedure described above, a tungsten trioxide layer 21 is deposited on the base body 12 which is in the form of a sintered ceramic, where the layer material of the tungsten trioxide layer 21 is more than 50% orthorhombic phase and has a porous nanostructure which includes gaps 22 that grow from the grain boundaries of the sintered ceramic and that extend along the layer thickness of the tungsten trioxide layer through the tungsten trioxide layer 21. The tungsten trioxide layer 21 of a component according to the invention is further characterized in that it has crystallites with a size of 2 nm to 200 nm and a porosity of 5% to 50%. In a preferred embodiment, the tungsten trioxide layer 21 has crystallites with a size of 5 nm to 50 nm and a porosity of 10% to 30%. The size of the crystallites of the tungsten trioxide layer 21 can be adjusted using known means. Essentially, two parameters or two trends need to be coordinated. First, the greater the temperature to which the base body 12 is heated by means of the heating device 17, the larger the crystallites become. Second, the more the growing tungsten trioxide layer is exposed to ions originating from the sputtering process, the smaller the crystallites become. It is therefore possible, for example in laboratory experiments, to determine to what temperature above 400° C. a base body must be heated and which magnetron parameters must be set in order to achieve a desired crystallite size when depositing the tungsten trioxide layer 21.

It has been shown that a tungsten trioxide layer 21 having the previously stated layer structure parameters has superhydrophilic properties, where it was possible to demonstrate contact angles of approximately 0°. In contrast, it was not possible for ceramic substrates that are not sintered ceramics to form such a layer structure as previously described and consequently to achieve superhydrophilic properties. In contrast, a sintered ceramic as a base body 12 causes pores and even entire gaps 22, which have a positive effect on the hydrophilic surface properties, to form during the growth of the tungsten trioxide layer 21, starting from the grain boundaries of the sintered ceramic.

According to the invention, the tungsten trioxide layer 21 can be formed with a layer thickness of 0.1 μm to 5 μm. In a preferred embodiment, in a ceramic component according to the invention, the tungsten trioxide layer 21 deposited at least within a surface region on the base body 12 has a layer thickness of 0.5 μm to 2 μm.

In one embodiment of the method according to the invention, the introduction of the reactive gas oxygen into the vacuum chamber 11 is controlled when a reactive deposition process for the tungsten trioxide layer 21 is carried out. For this purpose, an actual value for the intensity of at least one spectral line of at least one chemical element involved in the magnetron sputtering process is recorded by means of at least one sensor 18, compared to a target value, and, depending on the comparison result, the introduction of the reactive gas oxygen into the vacuum chamber 11 is controlled. It has been shown that such control can keep the layer structure constant during layer growth. The sensor 18 can be designed as a spectrometer, for example. In the exemplary embodiment described in FIG. 1, the actual values for the intensity of the spectral lines of two chemical elements involved in the sputtering process are recorded by means of the sensor 18. A first actual value for the intensity of a spectral line of the reactive gas oxygen is recorded and a second actual value for the intensity of a spectral line of the working gas argon is recorded. A quotient is then formed, from the first actual value and the second actual value, in an evaluation device not shown in FIG. 1, the quotient is compared to a target value and, depending on the comparison result, the amount of the reactive gas oxygen flowing through the first inlet 15 into the vacuum chamber 11 is controlled.

As previously explained, an inventive ceramic component has superhydrophilic properties in the surface region in which a tungsten trioxide layer 21 was deposited according to the invention. A ceramic component according to the invention can therefore be used, for example, as part of a heat transfer device functioning according to the heat pipe principle. A ceramic component according to the invention is further characterized in that the superhydrophilic surface region coated with a tungsten trioxide layer 21 can be wetted with a liquid several times per second and the liquid film can also be removed again. Such a component can therefore also be used in a heat transfer device that is designed as part of an electrocaloric heat pump.

In a further embodiment of the invention, another tungsten layer 33 is deposited between the base body 12 and a tungsten trioxide layer 31 according to the invention and consists of more than 50% crystalline α-tungsten and has crystallites with a size of 50 nm to 1000 nm, preferably 100 nm to 500 nm. Such a tungsten layer 33 can be deposited, for example, using the apparatus 10 shown in FIG. 1 as follows. First, the base body 12 is heated to a temperature of at least 400° C. using the heating device 17. After the base body 12 has been heated, the tungsten target 14 is sputtered by means of the magnetron 13 through the first inlet 15 without oxygen supply, so that tungsten particles are deposited on the base body 12. After the complete deposition of the tungsten layer 33, the oxygen supply through the first inlet 15 is additionally switched on and a tungsten trioxide layer 31 is deposited on the base body 12, which has been heated to at least 400° C., and on the tungsten layer 33 located thereon, using the reactive deposition process described above. It has been shown that a tungsten layer 33 deposited on the base body 12 in this way also forms pores and gaps that can then continue as gaps 32 in the overlying tungsten trioxide layer 31. If a component according to the invention is used as part of an electrocaloric heat pump, the tungsten layer 33 can be used as an electrode layer for applying an electric field, for example. Such a tungsten layer 33 is to be deposited with a layer thickness of 0.1 μm to 10 μm and preferably with a layer thickness of 1 μm to 5 μm.

In a further embodiment, a mixed layer is deposited on the tungsten trioxide layer 21 or the tungsten trioxide layer 31 and includes titanium oxide and silicon oxide with a mixing ratio of 10:1 to 1:10 and preferably a mixing ratio of 3:1 to 1:3. Surprisingly, it has been found that with 10 of such a mixed layer on the tungsten trioxide layer 21 or 31, the superhydrophilic properties can be maintained in a long-term stable manner. It has been demonstrated that the superhydrophilic properties of a component designed according to the invention can be maintained for a period of 12 months. A previously described mixed layer can be deposited, for example, reactively or non-reactively in the vacuum chamber 10 or alternatively in another vacuum chamber by means of known magnetron sputtering methods.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. A ceramic component having a superhydrophilic surface region, the ceramic component comprising a base body consisting of a sintered ceramic, on the surface of which, at least within the superhydrophilic surface region, a tungsten trioxide layer is deposited, wherein the layer material of the tungsten trioxide layer
is more than 50% orthorhombic phase and
has a porous nanostructure comprising gaps that grow from the grain boundaries of the sintered ceramic and extend along the thickness of the tungsten trioxide layer through the tungsten trioxide layer.

2. The component of claim 1, wherein the tungsten trioxide layer has a layer thickness of 0.1 μm to 5 μm.

3. The component of claim 1, wherein the tungsten trioxide layer has crystallites with a size of 2 nm to 200 nm and a porosity of 5% to 50%.

4. The component of claim 1, wherein a tungsten layer has a layer thickness of 0.1 μm to 10 μm and is deposited between the base body and the tungsten trioxide layer.

5. The component of claim 4, wherein the tungsten layer comprises more than 50% crystalline α-tungsten and has crystallites with a size of 50 nm to 1000 nm.

6. The component of claim 1, wherein a mixed layer of titanium oxide and silicon oxide having a layer thickness of 0.05 μm to 2 μm is deposited on the tungsten trioxide layer.

7. The component of claim 1, wherein the component is included in a heat transfer device configured to function according to the heat pipe principle.

8. The component of claim 7, wherein the heat transfer device is a component of an electrocaloric heat pump.

9. A method for manufacturing a ceramic component having a superhydrophilic surface region, wherein within a vacuum chamber
a) a base body, consisting of a sintered ceramic, is heated to a temperature of at least 400° C. and
b) then a tungsten trioxide layer is deposited on the heated base body, at least within the superhydrophilic surface region, by a pulsed magnetron sputtering process, wherein a pulse frequency in the range of 0.5 kHz to 100 kHz is used.

10. The method of claim 9 comprising applying a reactive magnetron sputtering process in which at least one tungsten target is sputtered by at least one magnetron while simultaneously introducing the reactive gas oxygen into the vacuum chamber.

11. The method of claim 10, wherein an actual value for the intensity of at least one spectral line of at least one chemical element involved in the magnetron sputtering process is recorded by at least one sensor, compared to a target value, and, depending on the comparison result, the introduction of the reactive gas oxygen into the vacuum chamber is controlled.
